(19) United States
(12) Patent Application Publication
(10) Pub. No.: US 2023/0147423 A1
(43) Pub. Date: May 11, 2023

(54) BEAM SWITCH CAPABILITY INDICATION AND GAP TIME MANAGEMENT FOR HIGHER FREQUENCY BANDS

(71) Applicant: QUALCOMM Incorporated, San Diego, CA (US)

(72) Inventors: Tianyang BAI, Somerville, NJ (US); Yan ZHOU, San Diego, CA (US); Mostafa KHOSHNEVISAN, San Diego, CA (US); Jing SUN, San Diego, CA (US); Junyi LI, Fairless Hills, PA (US); Tao LUO, San Diego, CA (US)

(21) Appl. No.: 17/821,237

(22) Filed: Aug. 22, 2022

Related U.S. Application Data
(60) Provisional application No. 63/263,636, filed on Nov. 5, 2021.

(51) Int. Cl. H04B 7/08; H04L 5/00; H04W 16/28; H04L 27/26

(52) U.S. Cl. CPC H04B 7/088; H04L 5/0051; H04W 16/28; H04L 27/2605

(57) ABSTRACT

Various aspects of the present disclosure generally relate to wireless communication. In some aspects, a mobile station may transmit beam switch capability information that indicates a minimum beam switch time for one or more beam switch types. The mobile station may receive a command to perform a beam switch associated with a beam switch type. The mobile station may perform the beam switch in a time period between a first signal and a second signal, wherein the time period has a duration that satisfies the minimum beam switch time for the beam switch type associated with the beam switch. Numerous other aspects are described.

### CROSS-REFERENCE TO RELATED APPLICATION

This patent application claims priority to U.S. Provisional Patent Application No. 63/263,636, filed on Nov. 5, 2021, entitled “BEAM SWITCH CAPABILITY INDICATION AND GAP TIME MANAGEMENT FOR HIGHER FREQUENCY BANDS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses associated with a beam switch capability indication and gap time management for higher frequency bands.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a mobile station. The method may include transmitting, by the mobile station to a network node, beam switch capability information that indicates a minimum beam switch time for one or more beam switch types. The method may include receiving, by the mobile station from the network node, a command to perform a beam switch associated with a beam switch type. The method may include performing, by the mobile station, the beam switch in a time period between a first signal and a second signal, wherein the time period has a duration that satisfies the minimum beam switch time for the beam switch type associated with the beam switch.

Some aspects described herein relate to a method of wireless communication performed by a network node. The method may include receiving, by the network node from a mobile station, beam switch capability information that indicates a minimum beam switch time for one or more beam switch types. The method may include transmitting, by the network node to the mobile station, a command to perform a beam switch associated with a beam switch type in a time period between a first signal and a second signal, wherein the time period has a duration that is based at least in part on the minimum beam switch time for the beam switch type associated with the beam switch.

Some aspects described herein relate to a mobile station for wireless communication. The mobile station may include a memory and one or more processors coupled to the memory. The one or more processors may be configured to, based at least in part on information stored in the memory, transmit, to a network node, beam switch capability information that indicates a minimum beam switch time for one or more beam switch types. The one or more processors may be configured to, based at least in part on information stored in the memory, receive, from the network node, a command to perform a beam switch associated with a beam switch type. The one or more processors may be configured to, based at least in part on information stored in the memory, perform the beam switch in a time period between a first signal and a second signal, wherein the time period has a duration that satisfies the minimum beam switch time for the beam switch type associated with the beam switch.

Some aspects described herein relate to a network node for wireless communication. The network node may include a memory and one or more processors coupled to the memory. The one or more processors may be configured to, based at least in part on information stored in the memory, receive, from a mobile station, beam switch capability information that indicates a minimum beam switch time for one or more beam switch types. The one or more processors may be configured to, based at least in part on information stored in the memory, transmit, to the mobile station, a command to perform a beam switch associated with a beam switch type in a time period between a first signal and a second signal, wherein the time period has a duration that is based at least in part on the minimum beam switch time for the beam switch type associated with the beam switch.

Some aspects described herein relate to a non-transitory computer-readable medium that stores a set of instructions for wireless communication by a mobile station. The set of instructions, when executed by one or more processors of the mobile station, may cause the mobile station to transmit, to a network node, beam switch capability information that indicates a minimum beam switch time for one or more beam switch types. The set of instructions, when executed by one or more processors of the mobile station, may cause the mobile station to receive, from the network node, a command to perform a beam switch associated with a beam switch type. The set of instructions, when executed by one or more processors of the mobile station, may cause the mobile station to perform the beam switch in a time period between a first signal and a second signal, wherein the time period has a duration that satisfies the minimum beam switch time for the beam switch type associated with the beam switch.

Some aspects described herein relate to a non-transitory computer-readable medium that stores a set of instructions for wireless communication by a network node. The set of instructions, when executed by one or more processors of the network node, may cause the network node to receive, from a mobile station, beam switch capability information that indicates a minimum beam switch time for one or more beam switch types. The set of instructions, when executed by one or more processors of the network node, may cause the network node to transmit, to the mobile station, a command to perform a beam switch associated with a beam switch type in a time period between a first signal and a second signal, wherein the time period has a duration that is based at least in part on the minimum beam switch time for the beam switch type associated with the beam switch.

Some aspects described herein relate to an apparatus for wireless communication. The apparatus may include means for transmitting, to a network node, beam switch capability information that indicates a minimum beam switch time for one or more beam switch types. The apparatus may include means for receiving, from the network node, a command to perform a beam switch associated with a beam switch type. The apparatus may include means for performing the beam switch in a time period between a first signal and a second signal, wherein the time period has a duration that satisfies the minimum beam switch time for the beam switch type associated with the beam switch.

Some aspects described herein relate to an apparatus for wireless communication. The apparatus may include means for receiving, from a mobile station, beam switch capability information that indicates a minimum beam switch time for one or more beam switch types. The apparatus may include means for transmitting, to the mobile station, a command to perform a beam switch associated with a beam switch type in a time period between a first signal and a second signal, wherein the time period has a duration that is based at least in part on the minimum beam switch time for the beam switch type associated with the beam switch.

Aspects generally include a method, apparatus, system, computer program product, non-transitory computer-readable medium, user equipment, mobile station, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example beamforming architecture that supports beamforming for millimeter wave communications, in accordance with the present disclosure.

FIG. 4 is a diagram illustrating examples of channel state information reference signal beam management procedures, in accordance with the present disclosure

FIG. 5 is a diagram illustrating an example of using beams for communications between a network node and a UE, in accordance with the present disclosure.

FIG. 6 is a diagram illustrating an example of time offsets associated with downlink control information used to indicate a beam switch, in accordance with the present disclosure.

FIG. 7 is a diagram illustrating an example of a beam switch associated with a beam switch delay, in accordance with the present disclosure.

FIG. 8 is a diagram illustrating an example associated with a beam switch capability indication and gap time management for higher frequency bands, in accordance with the present disclosure.

FIGS. 9-10 are diagrams illustrating example processes associated with a beam switch capability indication and gap time management for higher frequency bands, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

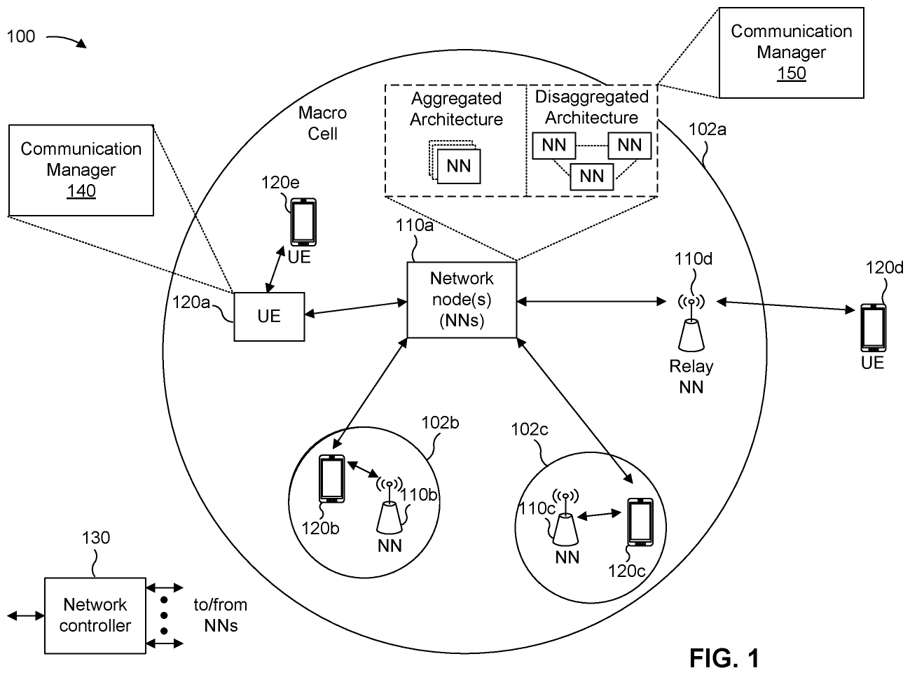

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node 110, beam switch capability information that indicates a minimum beam switch time for one or more beam switch types; receive, from the network node 110, a command to perform a beam switch associated with a beam switch type; and perform the beam switch in a time period between a first signal and a second signal, wherein the time period has a duration that satisfies the minimum beam switch time for the beam switch type associated with the beam switch. Additionally, or alternatively, the communication manager 140 may perform one or more other operations described herein.

In some aspects, the network node 110 may include a communication manager 150. As described in more detail elsewhere herein, the communication manager 150 may receive, from a UE 120, beam switch capability information that indicates a minimum beam switch time for one or more beam switch types; and transmit, to the UE 120, a command to perform a beam switch associated with a beam switch type in a time period between a first signal and a second signal, wherein the time period has a duration that is based at least in part on the minimum beam switch time for the beam switch type associated with the beam switch. Additionally, or alternatively, the communication manager 150 may perform one or more other operations described herein.

As indicated above, FIG. 1 is provided as an example. Other examples may differ from what is described with regard to FIG. 1.

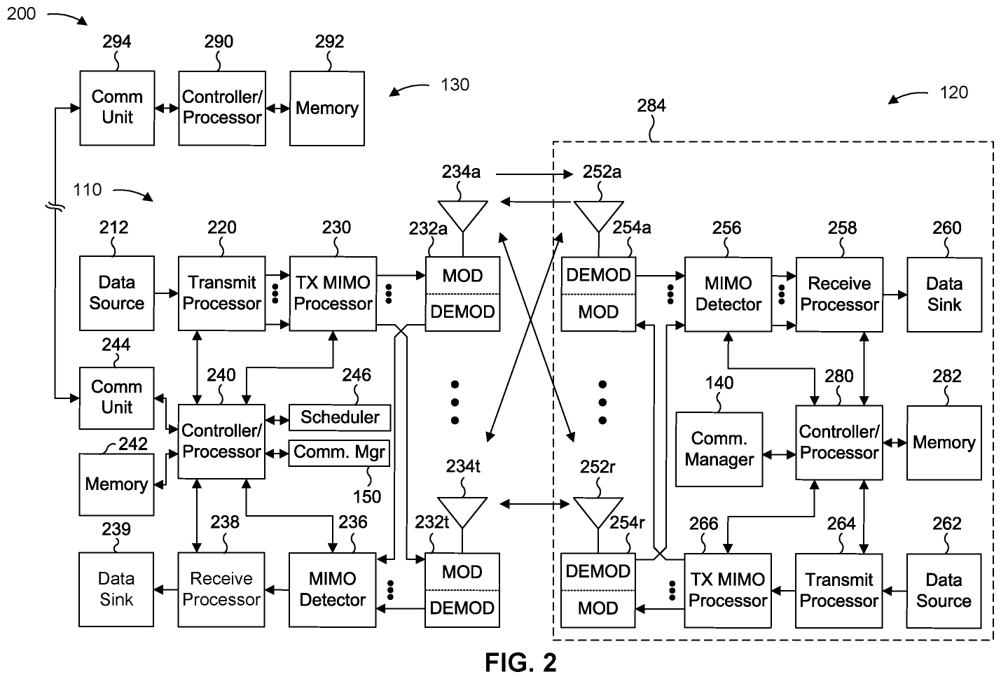

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

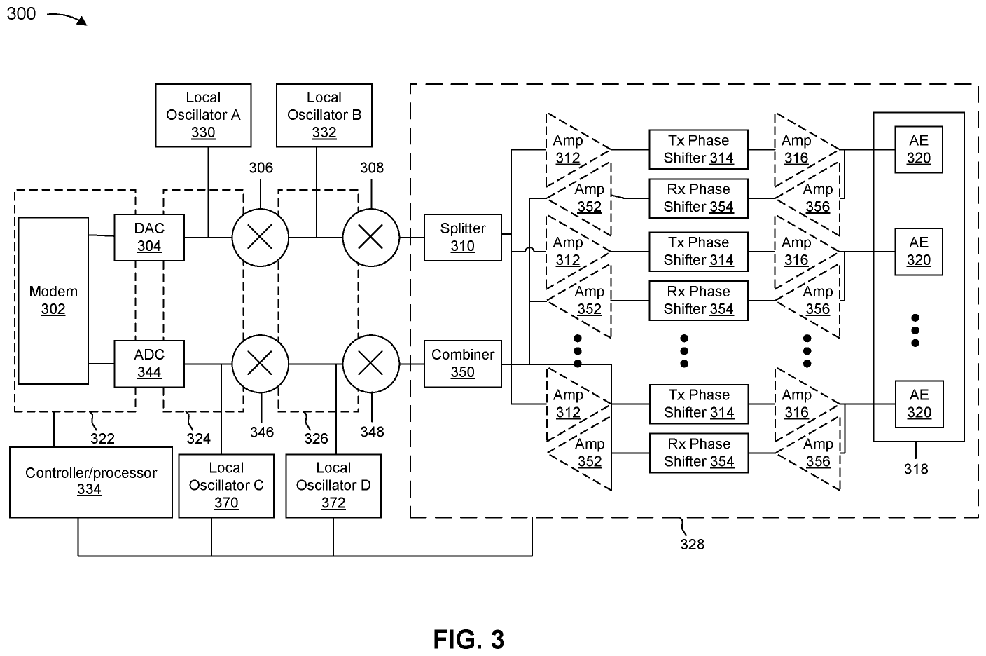

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

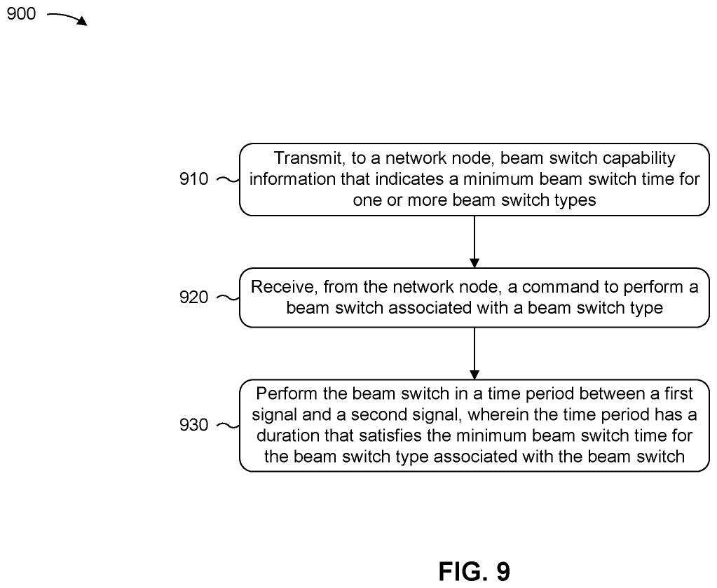

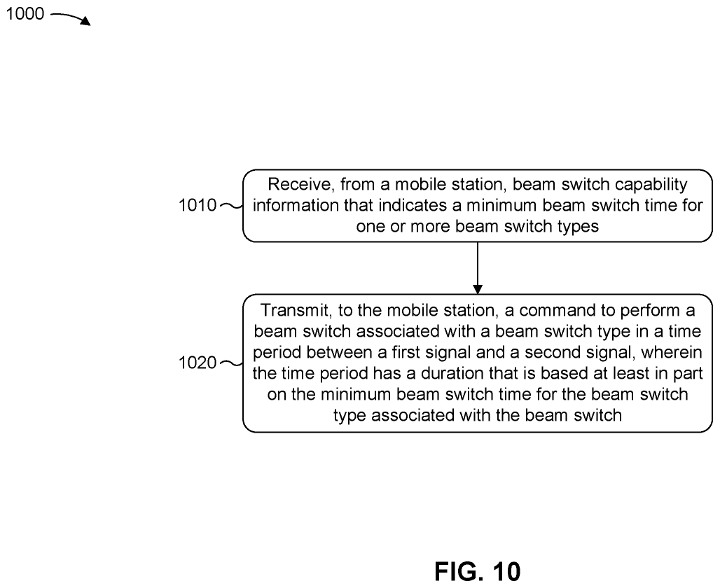

The controller/processor 240 of the network node 110, the controller/processor 280 of the UE 120, and/or any other component(s) of FIG. 2 may perform one or more techniques associated with a beam switch capability indication and gap time management for higher frequency bands, as described in more detail elsewhere herein. In some aspects, the mobile station described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for transmitting, to the network node 110, beam switch capability information that indicates a minimum beam switch time for one or more beam switch types; means for receiving, from the network node 110, a command to perform a beam switch associated with a beam switch type; and/or means for performing the beam switch in a time period between a first signal and a second signal, wherein the time period has a duration that satisfies the minimum beam switch time for the beam switch type associated with the beam switch. In some aspects, the means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a mobile station 120, beam switch capability information that indicates a minimum beam switch time for one or more beam switch types; and/or means for transmitting, to the mobile station 120, a command to perform a beam switch associated with a beam switch type in a time period between a first signal and a second signal, wherein the time period has a duration that is based at least in part on the minimum beam switch time for the beam switch type associated with the beam switch. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example beamforming architecture that supports beamforming for millimeter wave (mmW) communications, in accordance with the present disclosure. In some aspects, architecture 300 may implement aspects of wireless network 100. In some aspects, architecture 300 may be implemented in a transmitting device (e.g., a first wireless communication device, UE, or network node) and/or a receiving device (e.g., a second wireless communication device, UE, or network node), as described herein.

Broadly, FIG. 3 is a diagram illustrating example hardware components of a wireless communication device in accordance with certain aspects of the disclosure. The illustrated components may include those that may be used for antenna element selection and/or for beamforming for transmission of wireless signals. There are numerous architectures for antenna element selection and implementing phase shifting, only one example of which is illustrated in FIG. 3. The architecture 300 includes a modem (modulator/demodulator) 302, a digital to analog converter (DAC) 304, a first mixer 306, a second mixer 308, and a splitter 310. The architecture 300 also includes multiple first amplifiers 312, multiple phase shifters 314, multiple second amplifiers 316, and an antenna array 318 that includes multiple antenna elements 320. In some examples, the modem 302 may be one or more of the modems 232 or modems 254 described in connection with FIG. 2.

Transmission lines or other waveguides, wires, and/or traces are shown connecting the various components to illustrate how signals to be transmitted may travel between components. Reference numbers 322, 324, 326, and 328 indicate regions in the architecture 300 in which different types of signals travel or are processed. Specifically, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog radio frequency (RF) signals travel or are processed. The architecture also includes a local oscillator A 330, a local oscillator B 332, and a controller/processor 334. In some aspects, controller/processor 334 corresponds to controller/processor 240 of the network node described above in connection with FIG. 2 and/or controller/processor 280 of the UE described above in connection with FIG. 2.

Each of the antenna elements 320 may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (e.g., to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range.

The modem 302 may process and/or generate digital baseband signals and may also control operation of the DAC 304, first and second mixers 306, 308, splitter 310, first amplifiers 312, phase shifters 314, and/or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 may upconvert analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 may upconvert the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 and/or the controller/processor 334 may adjust the frequency of local oscillator A 330 and/or the local oscillator B 332 so that a desired IF and/or RF frequency is produced and used to facilitate processing and transmission of a signal within a desired bandwidth.

In the illustrated architecture 300, signals upconverted by the second mixer 308 may be split or duplicated into multiple signals by the splitter 310. The splitter 310 in architecture 300 may split the RF signal into multiple identical or nearly identical RF signals. In other examples, the split may take place with any type of signal, including with baseband digital, baseband analog, or IF analog signals. Each of these signals may correspond to an antenna element 320, and the signal may travel through and may be processed by amplifiers 312, 316, phase shifters 314, and/or other elements corresponding to the respective antenna element 320 to be provided to and transmitted by the corresponding antenna element 320 of the antenna array 318. In one example, the splitter 310 may be an active splitter that is connected to a power supply and configured to provide some gain so that RF signals exiting the splitter 310 are at a power level equal to or greater than the signal entering the splitter 310. In another example, the splitter 310 may be a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312, 316 are illustrated with dashed lines because one or both of amplifiers 312, 316 might not be present in some aspects. In some aspects, both the first amplifier 312 and second amplifier 316 are present. In some aspects, neither the first amplifier 312 nor the second amplifier 316 is present. In some aspects, one of the two amplifiers 312, 316 is present but not the other. By way of example, if the splitter 310 is an active splitter, the first amplifier 312 might not be present. By way of further example, if the phase shifter 314 is an active phase shifter that can provide a gain, the second amplifier 316 might not be present.

The amplifiers 312, 316 may provide a desired level of positive or negative gain. A positive gain (positive decibel (dB)) may be used to increase an amplitude of a signal for radiation by a specific antenna element 320. A negative gain (negative dB) may be used to decrease an amplitude and/or suppress radiation of the signal by a specific antenna element. Each of the amplifiers 312, 316 may be controlled independently (e.g., by the modem 302 or the controller/processor 334) to provide independent control of the gain for each antenna element 320. For example, the modem 302 and/or the controller/processor 334 may have at least one control line connected to each of the splitter 310, first amplifiers 312, phase shifters 314, and/or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 may be independent, meaning that each of the phase shifters 314 can be independently set to provide a desired amount of phase shift or the same amount of phase shift or some other configuration. The modem 302 and/or the controller/processor 334 may have at least one control line connected to each of the phase shifters 314, and the at least one control line may be used to configure the phase shifters 314 to provide a desired amount of phase shift or phase offset between antenna elements 320.

In the illustrated architecture 300, RF signals received by the antenna elements 320 are provided to one or more first amplifiers 356 to boost the signal strength. The first amplifiers 356 may be connected to the same antenna arrays 318 (e.g., for time division duplex (TDD) operations). The first amplifiers 356 may be connected to different antenna arrays 318. The boosted RF signal may be input into one or more phase shifters 354 to provide a configurable phase shift or phase offset for the corresponding received RF signal to enable reception via one or more receive (Rx) beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 and/or the controller/processor 334 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 and/or 356 are illustrated in dashed lines because the amplifiers 352 and/or 356 might not be present in some aspects. In some aspects, both the amplifier 352 and the amplifier 356 are present. In another aspect, neither the amplifier 352 nor the amplifier 356 are present. In other aspects, one of the amplifiers 352, 356 is present but not the other.

In the illustrated architecture 300, signals output by the phase shifters 354 (via the amplifiers 352 when present) may be combined in combiner 350. The combiner 350 in architecture 300 may combine the RF signal into a signal. The combiner 350 may be a passive combiner (e.g., not connected to a power source), which may result in some insertion loss. The combiner 350 may be an active combiner (e.g., connected to a power source), which may result in some signal gain. When combiner 350 is an active combiner, the combiner 350 may provide a different (e.g., configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 may be input into mixers 348 and 346. Mixers 348 and 346 generally down convert the received RF signal using inputs from local oscillators 372 and 370, respectively, to create intermediate or baseband signals that carry the encoded and modulated information. The output of the mixers 348 and 346 may be input into an analog-to-digital converter (ADC) 344 for conversion to digital signals. The digital signals output from ADC 344 may be input to modem 302 for baseband processing, such as decoding, de-interleaving, or similar operations.

The architecture 300 is given by way of example only to illustrate an architecture for transmitting and/or receiving signals. In some cases, the architecture 300 and/or each portion of the architecture 300 may be repeated multiple times within an architecture to accommodate or provide an arbitrary number of RF chains, antenna elements, and/or antenna panels. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, and/or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (e.g., represented by different ones of the reference numbers 322, 324, 326, 328) in different implemented architectures. For example, a split of the signal to be transmitted into multiple signals may take place at the analog RF, analog IF, analog baseband, or digital baseband frequencies in different examples. Similarly, amplification and/or phase shifts may also take place at different frequencies. For example, in some aspects, one or more of the splitter 310, amplifiers 312, 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first and/or or second amplifiers 312, 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (e.g., for each antenna element chain) within the second mixer 308, and the local oscillator B 332 may supply different local oscillator signals (with different phase offsets) to each IF to RF mixer.

The modem 302 and/or the controller/processor 334 may control one or more of the other components 304 through 372 to select one or more antenna elements 320 and/or to form beams for transmission of one or more signals. For example, the antenna elements 320 may be individually selected or deselected for transmission of a signal (or signals) by controlling an amplitude of one or more corresponding amplifiers, such as the first amplifiers 312 and/or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact, interfere (constructive and destructive interference), and amplify each other to form a resulting beam. The shape (e.g., the amplitude, width, and/or presence of side lobes) and the direction (e.g., angle of the beam relative to a surface of the antenna array 318) can be dynamically controlled by modifying the phase shifts or phase offsets imparted by the phase shifters 314 and amplitudes imparted by the amplifiers 312, 316 of the multiple signals relative to each other. The controller/processor 334 may be located partially or fully within one or more other components of the architecture 300. For example, the controller/processor 334 may be located within the modem 302 in some aspects.

As indicated above, FIG. 3 is provided as an example. Other examples may differ from what is described with regard to FIG. 3.

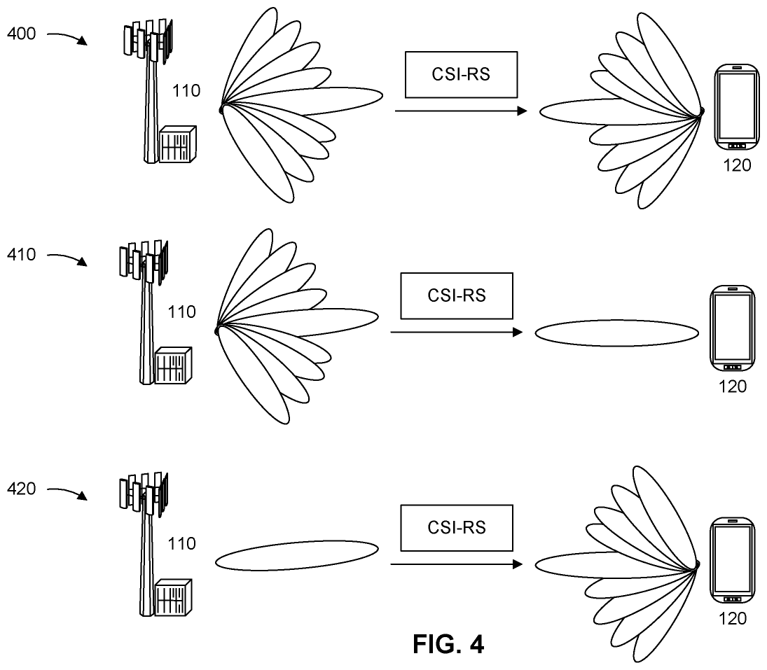

FIG. 4 is a diagram illustrating examples 400, 410, and 420 of channel state information reference signal (CSI-RS) beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an integrated access and backhaul (IAB) child node and an IAB parent node, and/or between a scheduled node and a scheduling node). In some aspects, the UE 120 and the network node 110 may be in a connected state (e.g., a radio resource control (RRC) connected state).

As shown in FIG. 4, example 400 may include a network node 110 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform Rx beam sweeping, the network node may use a transmit beam to transmit (e.g., with repetitions) each CSI-RS at multiple times within the same resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In some aspects, in connection with one or more beam management procedures (e.g., a beam selection procedure, a transmit beam refinement procedure, and/or a receive beam refinement procedure, among other examples), the UE 120 may report, to the network node 110, a list of UE capability value sets in cases where multiple codebook-based sounding reference signal (SRS) resource sets with different SRS port numbers are configured. In some aspects, each UE capability value set in the list of capability value sets reported to the network node 110 may include a maximum supported number of SRS ports, a coherence type, and/or a maximum number of SRS resources per SRS resource set. Furthermore, the UE capability value set may be common across all bandwidth parts or component carriers in the same band (e.g., in FR2 or FR4). Furthermore, when multiple codebook-based SRS resource sets with different SRS port numbers are configured, the UE 120 may report, in beam reporting uplink control information (UCI), an index to identify a particular UE capability value set in the list that the UE 120 desires to support in a particular beam reporting occasion along with an SSB resource index (SSBRI) and CSI-RS resource index (CRI) pair and an associated Layer-1 RSRP (L1-RSRP) measurement. Accordingly, the index to the list may indicate to the network node 110 the maximum number of SRS ports, coherence type, and/or number of SRS resources per SRS resource set supported by the UE 120.

In some aspects, for multiple codebook-based SRS resource sets with different SRS port numbers, the network node 110 may be configured to indicate, to the UE 120, an SRS resource set identifier that corresponds to a selected SRS resource indicator (SRI). For example, in some aspects, the network node 110 may indicate the SRS resource set identifier that corresponds to the selected SRI in DCI that schedules a codebook-based uplink transmission. Accordingly, when the network node 110 transmits DCI to the UE 120 to schedule a codebook-based uplink transmission, the DCI may indicate the selected SRI for the codebook-based uplink transmission based on the SRS resource set identifier indicated in the DCI (e.g., because different SRS resource sets may be associated with different numbers of SRS ports). For example, in some aspects, the DCI may include an SRS resource set identifier field to indicate the SRS resource set identifier corresponding to the selected SRI, or the SRS resource set identifier may be indicated in one or more bits of an SRI field in the DCI scheduling the codebook-based uplink transmission. Alternatively, in some aspects, the SRS resource set identifier may be implicitly determined by the previously reported UE capability value set (e.g., after the network node 110 acknowledges the UE report indicating the list of UE capability value sets). Alternatively, only the SRI may be reported, and the SRI may be indexed across all SRS resources among different SRS resource sets rather than within the same SRS resource set (e.g., there is no need to indicate the SRS resource set identifier in the DCI because the indexed SRI indicates the SRS resource set identifier).

In some aspects, in connection with inter-cell beam management and/or inter-cell multi-TRP (mTRP) operation, event-driven beam reporting may be supported, where the UE 120 transmits one or more beam measurement reports to the network node when one or more triggering events are detected. In such cases, the UE 120 may trigger an L1-RSRP report when one or more triggering events are detected, and the UE 120 could potentially trigger multiple L1-RSRP reports if one or more triggering events are detected consecutively. Accordingly, to reduce reporting overhead, the UE 120 may be configured with a prohibit timer to prohibit the UE 120 from sending multiple MAC-CEs that include L1-RSRP reports (e.g., in a similar manner as may be configured for a power headroom report). Furthermore, for inter-cell beam management, a supported MAC-CE-based and/or DCI-based beam indication (e.g., using DCI format 1_1 and/or DCI format 1_2 with and without downlink assignment including the associated MAC-CE-based transmission configuration indication (TCI) state activation), the non-UE dedicated channels and/or signals (on which such inter-cell beam indication does not apply) may include all physical downlink control channel (PDCCH) receptions on one or more control resource sets (CORESETs) along with the respective physical downlink shared channel (PDSCH) receptions and respective physical uplink shared channel (PUSCH) and/or physical uplink control channel (PUCCH) transmissions if the CORESET(s) is associated with any Type0/0A/1/2/3 common search space (CSS) set. For inter-cell beam management, whether a retransmission is allowed for the same hybrid automatic repeat request (HARQ) process identifier (ID) on a different TRP and/or a different physical cell identifier (PCI) may be defined in a wireless communication standard or based on a capability of the UE 120. Where retransmission for the same HARQ process ID on a different TRP and/or a different PCI is based on the capability of the UE 120, the UE 120 may indicate the capability of the UE 120 in terms of a maximum number of HARQ IDs for cross-TRP/PCI retransmission.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a uplink transmit beam.

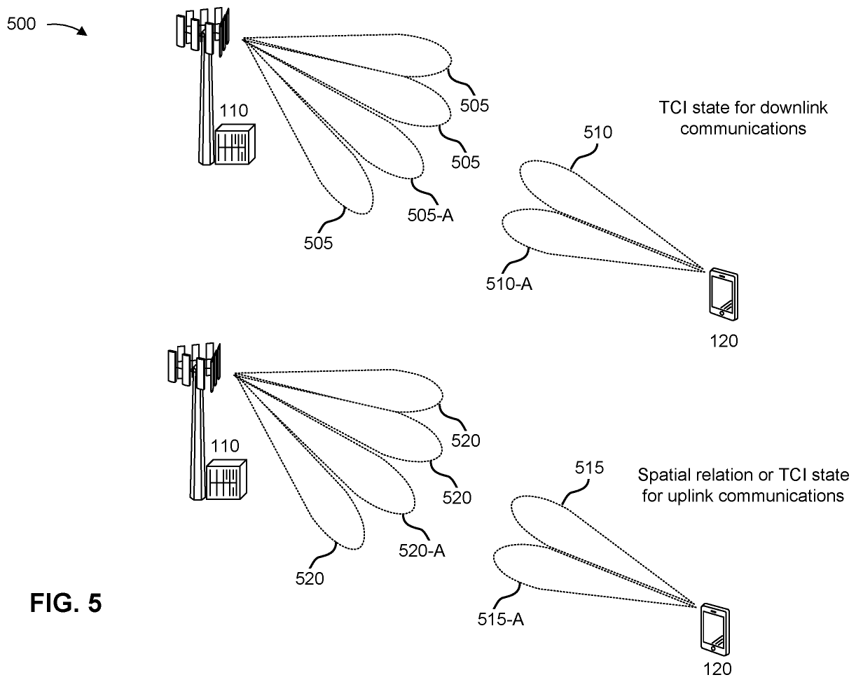

FIG. 5 is a diagram illustrating an example 500 of using beams for communications between a network node and a UE, in accordance with the present disclosure. As shown in FIG. 5, a network node 110 and a UE 120 may communicate with one another in a wireless network (e.g., wireless network 100).

The network node 110 may transmit to UEs 120 located within a coverage area of the network node 110. The network node 110 and the UE 120 may be configured for beamformed communications, where the network node 110 may transmit in the direction of the UE 120 using a directional downlink transmit beam, and the UE 120 may receive the transmission using a directional downlink receive beam. Each downlink transmit beam may have an associated beam ID, beam direction, or beam symbols, among other examples. The network node 110 may transmit downlink communications via one or more downlink transmit beams 505.

The UE 120 may attempt to receive downlink transmissions via one or more downlink receive beams 510, which may be configured using different beamforming parameters at receive circuitry of the UE 120. The UE 120 may identify a particular downlink transmit beam 505, shown as downlink transmit beam 505-A, and a particular downlink receive beam 510, shown as downlink receive beam 510-A, that provide relatively favorable performance (e.g., that have a best channel quality of the different measured combinations of downlink transmit beams 505 and downlink receive beams 510). In some examples, the UE 120 may transmit an indication of which downlink transmit beam 505 is identified by the UE 120 as a preferred downlink transmit beam, which the network node 110 may select for transmissions to the UE 120. The UE 120 may thus attain and maintain a beam pair link (BPL) with the network node 110 for downlink communications (e.g., a combination of the downlink transmit beam 505-A and the downlink receive beam 510-A), which may be further refined and maintained in accordance with one or more established beam refinement procedures (e.g., one or more of the beam refinement procedures described above with reference to FIG. 4).

A downlink beam, such as a downlink transmit beam 505 or a downlink receive beam 510, may be associated with a TCI state. A TCI state may indicate a directionality or a characteristic of the downlink beam, such as one or more quasi co-location (QCL) properties of the downlink beam with respect to a source reference signal. A QCL property may include, for example, a Doppler shift, a Doppler spread, an average delay, a delay spread, or spatial Rx parameters, among other examples. In some examples, each downlink transmit beam 505 may be associated with an SSB, and the UE 120 may indicate a preferred downlink transmit beam 505 by transmitting uplink transmissions in resources of the SSB that are associated with the preferred downlink transmit beam 505. A particular SSB may have an associated TCI state (e.g., for an antenna port or for beamforming). The network node 110 may, in some examples, indicate a downlink downlink transmit beam 505 based at least in part on antenna port QCL properties that may be indicated by the TCI state. A TCI state may be associated with one downlink reference signal set (e.g., an SSB and an aperiodic, periodic, or semi-persistent CSI-RS) for different QCL types (e.g., QCL types for different combinations of Doppler shift, Doppler spread, average delay, delay spread, or spatial Rx parameters, among other examples). In some aspects, the UE 120 may report to the network node a capability on which type of reference signals (e.g., among periodic, semi-persistent, aperiodic CSI-RS for CSI acquisition) the UE 120 supports to use as the source reference signal to establish a QCL type property of a TCI state. In cases where the QCL type indicates spatial Rx parameters (e.g., QCL-TypeD), the QCL type may correspond to analog receive beamforming parameters of a downlink receive beam 510 at the UE 120. Thus, the UE 120 may select a corresponding downlink receive beam 510 from a set of BPLs based at least in part on the network node 110 indicating a downlink transmit beam 505 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (e.g., activated PDSCH TCI states and activated CORESET TCI states) for the UE 120 may be configured by a configuration message, such as an RRC message (e.g., an RRCReconfiguration message).

Similarly, for uplink communications, the UE 120 may transmit in the direction of the network node 110 using a directional uplink transmit beam, and the network node 110 may receive the transmission using a directional uplink receive beam. Each uplink transmit beam may have an associated beam ID, beam direction, or beam symbols, among other examples. The UE 120 may transmit uplink communications via one or more uplink transmit beams 515.

The network node 110 may receive uplink transmissions via one or more uplink receive beams 520. The network node 110 may identify a particular uplink transmit beam 515, shown as uplink transmit beam 515-A, and a particular uplink receive beam 520, shown as uplink receive beam 520-A, that provide relatively favorable performance (e.g., that have a best channel quality of the different measured combinations of uplink transmit beams 515 and uplink receive beams 520). In some examples, the network node 110 may transmit an indication of which uplink transmit beam 515 is identified by the network node 110 as a preferred uplink transmit beam, which the network node 110 may select for transmissions from the UE 120. The UE 120 and the network node 110 may thus attain and maintain a BPL for uplink communications (e.g., a combination of the uplink transmit beam 515-A and the uplink receive beam 520-A), which may be further refined and maintained in accordance with one or more established beam refinement procedures. An uplink beam, such as a uplink transmit beam 515 or a uplink receive beam 520, may be associated with a spatial relation. A spatial relation may indicate a directionality or a characteristic of the uplink beam, similar to one or more QCL properties, as described above.

Additionally, or alternatively, as shown in FIG. 5, the network node 110 and the UE 120 may communicate using a unified TCI framework, in which case the network node 110 may use a TCI state to indicate a beam that the UE 120 is to use for uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide a QCL assumption (e.g., common QCL information) for UE-dedicated PDSCH reception and one or more CORESETs in a component carrier, or one or more source reference signals that provide a reference to determine one or more common uplink transmission spatial filters for a PUSCH based on a dynamic grant or a configured grant or one or more dedicated PUCCH resources in a component carrier.

Additionally, or alternatively, the unified TCI framework may support a separate downlink TCI state and a separate uplink TCI state to accommodate separate downlink and uplink beam indications (e.g., in cases where a best uplink beam does not correspond to a best downlink beam, or vice versa). In such cases, each valid uplink TCI state configuration may contain a source reference signal to indicate an uplink transmit beam for a target uplink communication (e.g., a target uplink reference signal or a target uplink channel). For example, the source reference signal may be an SRS, an SSB, or a CSI-RS, among other examples, and the target uplink communication may be a physical random access channel (PRACH), a PUCCH, a PUSCH, an SRS, and/or a DMRS (e.g., for a PUCCH or a PUSCH), among other examples. In this way, supporting joint TCI states or separate downlink and uplink TCI states may enable a unified TCI framework for downlink and uplink communications and/or may enable the network node 110 to indicate various uplink QCL relationships (e.g., Doppler shift, Doppler spread, average delay, or delay spread, among other examples) for uplink TCI communication.

In some aspects, in cases where the UE 120 and the network node 110 communicate using a unified TCI framework, the UE 120 may transmit, to the network node 110, information that indicates a capability to support one or more downlink or uplink channels or signals that can share the same indicated TCI state that is used for UE-dedicated reception on a PDSCH and/or PDCCH, a PUSCH based on a dynamic grant or a configured grant, and/or all dedicated PUCCH resources (e.g., via a TCI state updated indicated in a MAC-CE or DCI). For downlink channels and/or signals, the network node 110 may configure (e.g., via RRC messages) a non-UE dedicated PDCCH and/or PDSCH associated with a serving cell PCI, an aperiodic CSI-RS for beam management, or an aperiodic CSI-RS for CSI reporting sharing the same TCI state that is indicated for UE-dedicated reception on a PDSCH and/or PDCCH. Similarly, for uplink channels and/or signals, the network node 110 may configure (e.g., via RRC messages) an SRS for beam management, antenna switching, and/or codebook or non-codebook-based uplink transmission sharing the same TCI state that is indicated for a PUSCH based on a dynamic grant or a configured grant and/or all dedicated PUCCH resources.

In some aspects, for multi-PDSCH scheduling for multiple TRPs, DCI may include a single field (e.g., a Transmission Configuration Indication field) to indicate a TCI state to be used for multiple TRPs. In this case, when the UE receives DCI scheduling multiple PDSCHs with the single field to indicate the TCI state to be used for multiple TRPs, the UE 120 generally does not expect to be configured with a higher layer parameter indicating a number of repetitions (e.g., repetitionNumber) and/or a repetition scheme (e.g., repetitionScheme) set to a time division multiplexing (TDM) scheme (e.g., TDMSchemeA) in which the UE 120 receives two transport blocks that are transmitted in the PDSCH symbols in one slot via repetitions with two TCI states.

In some aspects, to ensure compliance with a maximum permissible exposure (MPE) limit that may be applicable to an uplink transmission from the UE 120, the UE 120 may be configured to send a MAC-CE report to the network node 110 (e.g., based on detecting a triggering event). In the MAC-CE report, one or more Power Management Maximum Power Reduction (P-MPR) values can be reported, where the UE can report one or more associated SSB resource indexes or CSI-RS resource indexes for each P-MPR value in the report, which may be selected from a candidate SSB/CSI-RS resource pool configured in RRC signaling. In addition, the UE 120 may report as a UE capability the maximum number of candidate reference signals that can be configured in a candidate SSB/CSI-RS resource pool for MPE mitigation to the network node 110.

As indicated above, FIG. 5 is provided as an example. Other examples may differ from what is described with respect to FIG. 5.

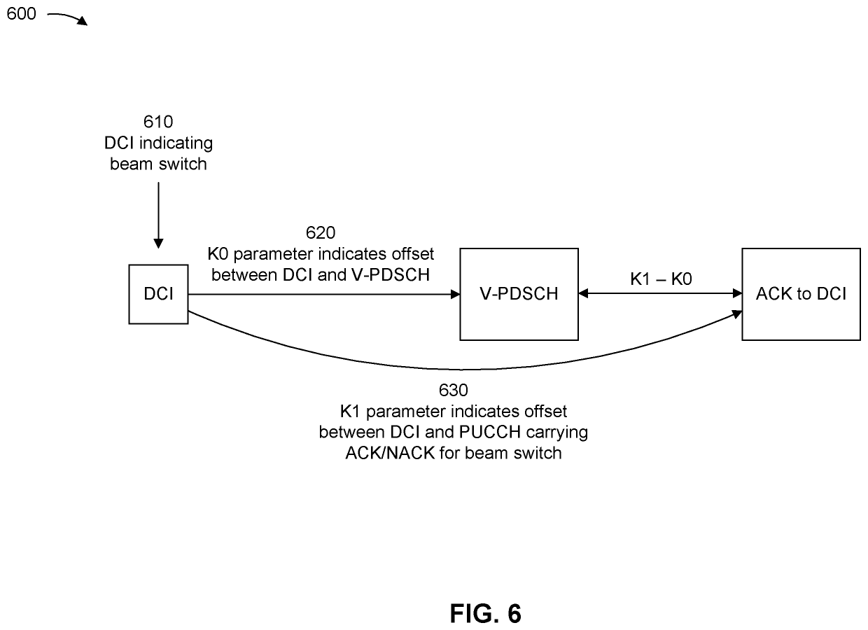

FIG. 6 is a diagram illustrating an example 600 of time offsets associated with DCI used to indicate a beam switch, in accordance with the present disclosure. For example, as shown in FIG. 6, and by reference number 610, a network node 110 may transmit DCI to a UE 120 to indicate a beam switch (e.g., an updated TCI state) without a downlink assignment. In some cases, as shown by reference number 620, the DCI may schedule a virtual PDSCH (v-PDSCH), and a K0 parameter may indicate an offset between the DCI indicating the updated TCI state and the V-PDSCH. Furthermore, as shown by reference number 630, the DCI may include a K1 parameter that indicates an offset between the DCI and the PUCCH carrying acknowledgement/negative acknowledgement (ACK/NACK) feedback for the DCI indicating the beam switch (e.g., the ACK/NACK is for the DCI indicating the beam switch rather than the V-PDSCH scheduled by the DCI because the DCI does not include a downlink assignment or otherwise schedule downlink data). In this case, for Type-1 HARQ-ACK codebook, if the DCI includes a time domain resource allocation that indicates the K0 parameter for the V-PDSCH and a value of the K1 parameter for HARQ-ACK timing, then K1−K0 has a value included among an allowable set of slot timing values defined in a wireless communication standard (e.g., a difference between K1 and K0 must fall in the allowable set of values, sometimes referred to as a set of slot timing values K1, which is configured by the network node for regular PDSCH and ACK/NACK processes).

However, in the case of Type-1 HARQ-ACK codebook, one issue for the DCI used to update the TCI state without a downlink assignment is that the V-PDSCH occasion indicated in the DCI might fall outside a candidate K1 window of an indicated PUCCH resource carrying the codebook. For example, suppose the candidate K1 set includes two candidate values of K1={2, 4}, the DCI updating the TCI state without a downlink assignment is sent in slot n, the indicated V-PDSCH occasion is in slot n+1, and the indicated PUCCH for ACK/NACK is in slot n+2. In this example, the Type-1 codebook will only consider PDSCH occasions in slot n and n+2, and will not consider the indicated V-PDSCH occasion in slot n+1. Therefore, there is no valid ACK/NACK bit position for the DCI updating the TCI state, which is based on the V-PDSCH occasion. Accordingly, in some aspects, the V-PDSCH occasion indicated in the DCI may be included in the candidate K1 window, whereby the value of K1−K0 is among the set of slot timing values K1 defined in one or more wireless communication standards (e.g., in 38.213, Section 9.1.2.1), where the K1 parameter refers to the HARQ-ACK timing indicated in the DCI and determines the time offset between the DCI and the PUCCH, while the indicated K0 parameter refers to the time offset between the DCI and the V-PDSCH occasion.

As indicated above, FIG. 6 is provided as an example. Other examples may differ from what is described with respect to FIG. 6.

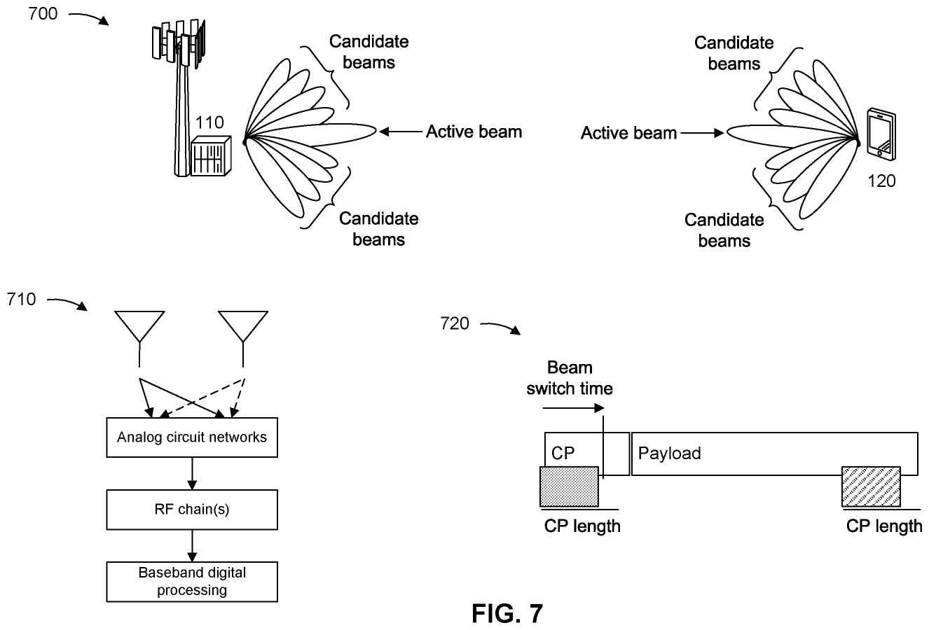

FIG. 7 is a diagram illustrating an example 700 of a beam switch associated with a beam switch delay, in accordance with the present disclosure. As shown in FIG. 7, example 700 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink. Furthermore, as described herein, the network node 110 and the UE 120 may communicate using one or more directional beams.

For example, as shown in FIG. 7, the network node 110 may communicate with the UE 120 using one or more active beams. In some aspects, the network node 110 and the UE 120 may also support communicating via one or more candidate beams. In some aspects, an active beam may be selected from a set of candidate beams by comparing beam parameters (e.g., an RSRP parameter, an RSRQ parameter, an RSSI parameter, and/or other suitable parameters) of the set of candidate beams. For example, an active beam may be a directional beam that has the best beam parameters among all beams in the set of candidate beams. In some aspects, the beams may operate in a millimeter wave (mmW) frequency band (e.g., in FR2 and/or FR4), which tends to be associated with highly complex RF conditions because mmW signals have a higher frequency and a shorter wavelength than various other radio waves used for communications (e.g., sub-6 GHz communications). As a result, compared to radio waves that fluctuate in a simple or predictable manner, mmW signals often have shorter propagation distances, may be subject to atmospheric attenuation, and/or may be more easily blocked and/or subject to penetration loss through objects or other obstructions. Accordingly, mmW communication may rely on directional beamforming to improve performance and satisfy a link budget, whereby a transmitter (e.g., the network node 110 on a downlink or the UE 120 on an uplink) may generate an active transmit beam that is steered in a particular direction and a receiver (e.g., the network node 110 on an uplink or the UE 120 on a downlink) may generate a corresponding active receive beam.

In some aspects, in cases where the active beam experiences a failure, or network conditions change such that another candidate beam has one or more better beam parameters than the active beam, then the network node 110 and the UE 120 may perform a beam switch procedure to switch away from the active beam and to a candidate beam. For example, in a mmW setting, the active beam may be reflected, diffracted, and/or scattered by one or more clusters, obstacles, and/or materials within an environment between or around the transmitter and the receiver. For example, a mmW signal may be reflected by lamp posts, vehicles, glass/window panes, and/or metallic objects, may be diffracted by edges or corners of buildings and/or walls, and/or may be scattered via irregular objects such as walls and/or human bodies (e.g., a hand blocking an antenna module when a device is operated in a gaming mode). In such cases, the beam switch may be performed to change the active beam direction(s) to a different candidate beam that offers better performance. After switching beams, the network node 110 and the UE 120 may no longer communicate via the previously active beam and may instead communicate via the activated candidate beam (e.g., which becomes the active beam). In some aspects, to switch away from an active beam, the network node 110 may transmit a beam switch command to instruct the UE 120 to switch active beams. The beam switch command may indicate, for example, a beam index for a beam to be activated and/or a timing for the switch, among other examples.

In general, in order to perform a beam switch, the UE 120 may need to change a spatial domain filter, which can cause an effective channel to be time-varying during the beam switch time. For example, reference number 710 depicts example components that may be included in a beamforming architecture (e.g., the beamforming architecture 300 described above with reference to FIG. 3), which may include multiple antenna elements coupled to one or more analog circuit networks, one or more RF chains, and one or more baseband digital processing components. Accordingly, directional beamforming can generally be applied by analog RF components in the analog circuit network(s) (e.g., phase shifters and/or switches) and/or in the digital domain. However, a change in beamforming directions, or beam switch, is typically achieved by changing a configuration associated with one or more RF components in the one or more analog circuit networks (e.g., by changing a phase response of one or more phase shifters). Accordingly, when a beam switch is performed to change beam directions, there may be a delay between a time when the configuration is changed in the analog circuit network(s) until a final settle time (e.g., around several hundred nanoseconds). As a result, the beam switch causes the effective channel to be time-varying, in that the time-varying unstable channel response during the beam switch differs from the stable beamformed channel after the final settle time.

In some cases, in order to mitigate the performance impact due to the time-varying effective channel that exists during the beam switch time, the beam switch may be configured to occur during a cyclic prefix of a symbol. For example, when the network node 110 and the UE 120 communicate using orthogonal frequency division multiplexing (OFDM) with a cyclic prefix (CP) (CP-OFDM) on the downlink, each symbol begins with a cyclic prefix with a repetition of the cyclic prefix at the end of the symbol. For example, the cyclic prefix at the start of each symbol provides a guard interval to eliminate or mitigate inter-symbol interference (ISI) from a previous symbol, and the cyclic prefix is repeated at the end of the symbol so that a linear convolution of a frequency-selective multipath channel can be modeled as a circular convolution, which in turn may transform to a frequency domain via a discrete Fourier transform. Accordingly, because the UE 120 typically discards cyclic prefix samples, the beam switch may be configured to occur within the cyclic prefix of a symbol.

For example, reference number 720 depicts an example where the beam switching time is within the cyclic prefix length, where the time-varying or unstable effective channel during the beam switch time (represented by the gray shaded box) may differ from the stable beamformed channel (represented by the box with dashed lines). In cases where the beam switch time is within the cyclic prefix length (e.g., as shown in FIG. 7), the difference in the effective channel during the beam switch time may not have a significant performance impact (e.g., because the cyclic prefix samples are typically discarded and the beam switch time does not overlap with the payload samples). However, in cases where the beam switch time exceeds the cyclic prefix length or is within a threshold of the cyclic prefix length (e.g., comparable or close to the cyclic prefix length such that the beam switch time has an effective length that exceeds the cyclic prefix length when combined with a propagation delay and/or a processing delay), the instability of the effective channel during the beam switch time may have a performance impact, such as increased ISI, because the beam switch time overlaps with the payload samples. Furthermore, in cases where the beam switch time or the effective beam switch time exceeds the cyclic prefix length, the beam switch may undermine the circular CP-OFDM structure and may cause error vector magnitude (EVM) loss and/or lower decoding rates. The performance impact of the beam switch in such cases may also depend on a symbol type. For example, in cases where additional EVM loss is experienced on a DMRS symbol, channel estimation may be corrupted and a resulting error may propagate to decoding all subsequent symbols, whereas EVM loss on a data symbol may only have a local impact (e.g., only on the data symbol in which the EVM loss is experienced). In another example, symbols that have a relatively low MCS may be robust to EVM loss, but symbols that have a relatively high MCS may be sensitive to EVM loss. Furthermore, a transmit beam switch may have a different settling time than a receive beam switch (e.g., the settling time is typically longer for a transmit beam switch), and switching the transmit beam generally has a longer impact time (even if the settling time is the same or comparable to the settling time for switching the receive beam) due to channel delay taps.

Accordingly, as described above, various performance impacts can occur when the beam switch time exceeds or is comparable to the cyclic prefix length, which may be more likely to occur in higher mmW frequency bands (e.g., in FR4 or FR5, which includes frequencies beyond 52.6 GHz). For example, in higher mmW frequency bands, a component carrier may be associated with a larger bandwidth and/or a larger tone spacing (often referred to as a subcarrier spacing). For example, at mmW frequencies higher than 52.6 GHz, a 960 kHz or larger tone spacing may be used to better handle phase noise and/or inter-carrier interference, to reduce a fast Fourier transform (FFT) and/or inverse FFT size (which equals the number of tones), and/or to reduce a transmission time interval length. Accordingly, because the symbol length is inversely proportional to the tone spacing (e.g., a larger tone spacing is associated with a shorter symbol length, and vice versa), the large tone spacing used in higher mmW bands can result in a short symbol length such that a beam switch time (or effective beam switch time) is more likely to exceed the cyclic prefix length. For example, when a 120 kHz tone spacing is used, a cyclic prefix length within a symbol is about 590 nanoseconds, which is sufficiently long to perform a beam switch that can typically settle within about 100 nanoseconds. However, increasing the tone spacing eight-fold from 120 kHz to 960 kHz results in a symbol length that is 8 times shorter, and the cyclic prefix length scales proportionately, resulting in a cyclic prefix length of about 75 nanoseconds when a 960 kHz tone spacing is used. Accordingly, at higher frequencies, the cyclic prefix length may be shorter than the beam switching time, or shorter than the effective beam switching time that takes propagation delays, processing delays, and/or other time-varying channel properties into consideration, which increases the likelihood that performing a beam switch will cause a performance impact.

Some aspects described herein relate to techniques and apparatuses to indicate a beam switch capability and manage a gap time for higher frequency bands (e.g., mmW frequency bands greater than 52.6 GHz). For example, a beam switch time may vary among different UE implementations, depending on the beamforming architecture used in a UE and/or other capabilities of a UE. Accordingly, in cases where a UE indicates a capability to perform a beam switch within a beam switch time that exceeds or is comparable to a cyclic prefix length, a network node may configure a scheduling gap after the beam switch to mitigate any performance impact that may otherwise result from the beam switch overlapping with one or more payload samples (e.g., while the analog beamforming components are in a transitional state and before the stable beamformed channel is achieved). Furthermore, because different beam switch types may be associated with different beam switch times, the beam switch capability indicated by a UE may indicate a minimum beam switch time for one or more beam switch types. Accordingly, the network node may take the beam switch capability of the UE into account to configure a scheduling gap after a beam switch and thereby avoid or mitigate performance impacts that may otherwise be caused by the beam switch. Additionally, or alternatively, in cases where the network node is unable to guarantee the scheduling gap after the beam switch (e.g., due to a scheduling restriction), the UE may be configured to apply one or more priority rules to drop one or more symbols before or after the beam switch in order to guarantee a sufficient gap to complete the beam switch. Furthermore, in some aspects, the beam switch capability provided by the UE may indicate a minimum time between two adjacent beam switches to mitigate performance impacts that may otherwise occur if the UE were to perform multiple beam switches close in time (e.g., performing a second beam switch before a settling time of a first beam switch).

As indicated above, FIG. 7 is provided as an example. Other examples may differ from what is described with respect to FIG. 7.

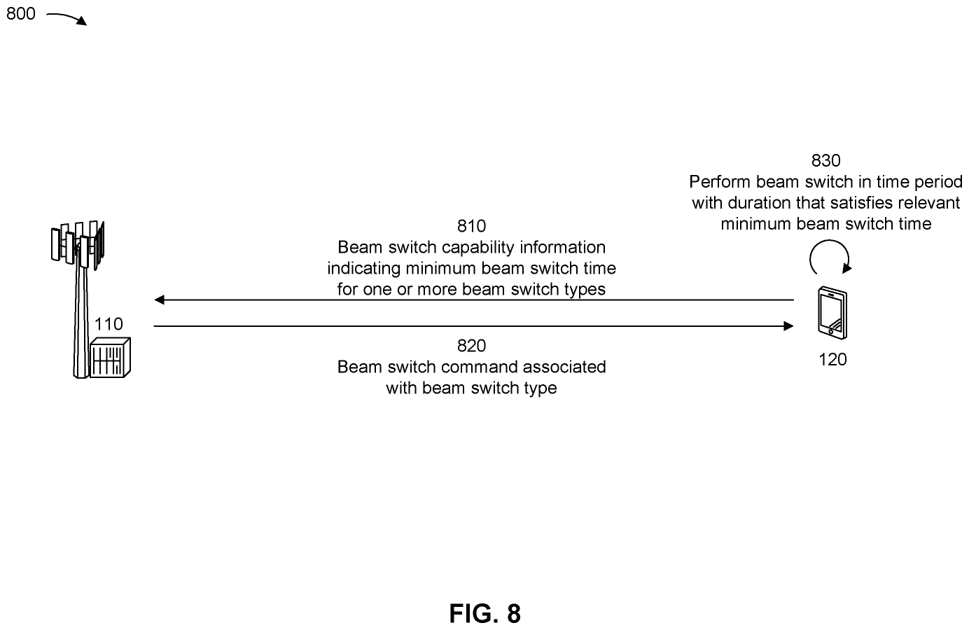

FIG. 8 is a diagram illustrating an example associated with a beam switch capability indication and gap time management for higher frequency bands, in accordance with the present disclosure. As shown in FIG. 8, example 800 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink. Furthermore, the network node 110 and the UE 120 may communicate using one or more directional beams.

As shown in FIG. 8, and by reference number 810, the UE 120 may transmit, and the network node 110 may receive, beam switch capability information that indicates a minimum beam switch time for one or more beam switch types (e.g., an amount of time that the UE 120 needs to change a configuration of one or more analog RF components to change a beam direction plus any additional time for the time-varying effective channel to settle to a stable beamformed channel due to the one or more analog RF components being in a transitional state during the beam switch). For example, as described herein, a beam switch may generally be performed between a first signal and a second signal (e.g., during a time period that at least partially overlaps with a cyclic prefix within a symbol), whereby the beam switch capability information may indicate the minimum beam switch time for one or more beam switch types, which may generally depend on the type or configuration of the first signal and the second signal.

For example, in some aspects, the beam switch capability information may indicate the minimum beam switch time for a beam switch performed between two downlink signals that have different QCL assumptions for a spatial Rx parameter (e.g., between a first downlink signal associated with a first QCL-TypeD assumption and a second downlink signal associated with a second QCL-TypeD assumption). In this way, indicating the minimum beam switch time for a beam switch performed between two downlink signals that have different QCL-TypeD assumptions may enable the network node 110 to configure a sufficient beam switch gap between any two downlink signals that are received using different beams, which may be specified by the network node 110 or defined in one or more wireless communication standards. Additionally, or alternatively, the beam switch capability information may indicate the minimum beam switch time for a beam switch performed between a downlink signal that has a QCL-TypeD assumption for a spatial Rx parameter and a downlink reference signal (e.g., an SSB or CSI-RS) without a QCL-TypeD assumption and/or a beam switch performed between two downlink reference signals (e.g., two CSI-RS resources) without any QCL-TypeD assumptions that are explicitly configured by the network node 110 or implicitly defined in one or more wireless communication standards. For example, in these cases, indicating the minimum beam switch time for the beam switch may enable the UE 120 to perform a search to find a corresponding refined receive beam for the downlink reference signal(s) that do not have a specified QCL-TypeD assumption during the beam switch gap. Additionally, or alternatively, the beam switch capability information may indicate the minimum beam switch time for a beam switch performed between two downlink reference signals (e.g., CSI-RS resources) that have the same QCL-TypeD assumption for a spatial Rx parameter in a resource set that is configured for repetitions (e.g., a higher layer parameter Repetition is set to “on” or is otherwise enabled). In this case, during the beam switch time, the UE 120 may be expected to perform a receive beam sweep across the downlink reference signal resources that are in the same resource set with repetitions enabled, where the downlink reference signal resources are indicated by the same TCI state and the TCI state is mapped to a refined receive beam.

Furthermore, in some aspects, the beam switch capability information may indicate the minimum beam switch time for one or more types of beam switches that are performed between two uplink signals. For example, in some aspects, the beam switch capability information may indicate the minimum beam switch time between two uplink signals that have different spatial relations (e.g., between a first uplink signal associated with a first spatial relation and a second uplink signal associated with a second spatial relation). In this way, indicating the minimum beam switch time for a beam switch performed between two uplink signals that have different spatial relation may enable the network node 110 to configure a sufficient beam switch gap between any two uplink signals that are transmitted using different uplink beams, which may be specified by the network node 110 or defined in one or more wireless communication standards. Additionally, or alternatively, the beam switch capability information may indicate the minimum beam switch time for a beam switch performed between an uplink signal that has a specified spatial relation and an uplink reference signal (e.g., an SRS) without a spatial relation and/or a beam switch performed between two uplink reference signals (e.g., two SRS resources) without any spatial relation explicitly configured by the network node 110, implicitly defined in one or more wireless communication standards, or otherwise specified. For example, in these cases, indicating the minimum beam switch time for the beam switch may enable the UE 120 to associate a fixed uplink transmit beam with an SRS resource for beam management without a specified spatial relation for a transmit beam sweep (e.g., during an uplink beam management procedure). Accordingly, in cases where the beam switch is performed between two uplink signals, one or more of which is an SRS resource without a specified spatial relation, the UE 120 may need a beam switch gap to select and/or configure the uplink transmit beam.

In some aspects, the beam switch capability information provided by the UE 120 may indicate separate beam switching times that the UE 120 needs to perform different beam switch types, such as separate beam switching times for each of the downlink and uplink beam switch types described above. For example, the UE 120 may need a longer beam switch time to perform a receive beam search during a beam switch performed between one or more downlink signals without a specified QCL-TypeD assumption compared to a beam switch time that is performed to refine a receive beam during a beam switch performed between downlink signals with specified QCL-TypeD assumptions. Alternatively, in some aspects, the beam capability information provided by the UE 120 may indicate a single value that applies to each beam switch type (e.g., to reduce overhead associated with the capability indication). Alternatively, in some aspects, the beam capability information provided by the UE 120 may indicate a first value that applies to each beam switch type between two downlink signals and a second value that applies to each beam switch type between two uplink signals (e.g., because the downlink-to-downlink beam switch times may be roughly similar and the uplink-to-uplink beam switch times may be roughly similar, but there may be a more significant time difference between an average downlink-to-downlink beam switch time and an average uplink-to-uplink beam switch time).

Furthermore, in some aspects, there may be a fixed beam switching time between adjacent SSBs, where the fixed beam switching time may generally equal or exceed (e.g., is not less than) the largest candidate value for the beam switching time that is reported in the beam switch capability information. In some aspects, the fixed beam switching time between adjacent SSBs may be specified in one or more wireless communication standards, or the fixed beam switching time may be configured by the network node 110. In some aspects, to avoid errors that may occur due to consecutive beam switches that are performed close in time, the beam switch capability information may further indicate a minimum interval between a start of two consecutive beam switches, where the minimum interval may include a value that is selected from a set of candidate values (e.g., 5 microseconds, 10 microseconds, and/or other suitable values).

As further shown in FIG. 8, and by reference number 820, the network node 110 may transmit, and the UE 120 may receive, a beam switch command associated with a beam switch type (e.g., between two downlink signals or two uplink signals, where a QCL-TypeD assumption, spatial relation, or other beam indication may or may not be specified for one signal, both signals, or neither signal). In some aspects, the beam switch command may indicate that the UE 120 is to perform the beam switch during a time period that has a duration that is based on the beam switch capability information. For example, in cases where the beam switch capability information indicates that the relevant beam switch type can be performed within a cyclic prefix length, the beam switch command may indicate that the beam switch is to be performed within the cyclic prefix of a symbol. Alternatively, in cases where the beam switch capability information indicates that the relevant beam switch type can be performed within a beam switch time that exceeds or is within a threshold of the cyclic prefix length, the beam switch command may configure a scheduling gap after the beam switch (e.g., such that the beam switch does not overlap with any payload samples), where a duration of the scheduling gap may be determined by the minimum beam switching time indicated in the beam switching capability information provided by the UE 120. As shown by reference number 830, the UE 120 may then perform the beam switch in the time period with the duration that is sufficient to satisfy the relevant minimum switching time, and the UE 120 and the network node 110 may then communicate using the new beam.

Alternatively, in some cases, the network node 110 may be unable to guarantee a sufficient scheduling gap after the beam switch. For example, the network node 110 may be unable to guarantee a sufficient scheduling gap in cases where there is a scheduling restriction, such as a beam switch to perform between two semi-persistent scheduling (SPS) occasions that are preconfigured by the network node 110 (e.g., with a configuration that can be updated based on one or more rules, signaling, or other configuration updates). In such cases, when a beam search is performed between two signals and the total gap that is provided for the beam switch fails to satisfy the beam switching capability of the UE 120 (e.g., the beam switch is performed between two signals that overlap in time, have no gap, or have a gap that is less than the minimum beam switching time indicated by the UE 120), the UE 120 may apply one or more priority rules to determine one or more symbols to drop before or after the beam switch in order to achieve the sufficient scheduling gap. In particular, the UE 120 may determine whether the first signal or the second signal has a higher priority, and the UE 120 may drop one or more symbols of the lower priority signal to guarantee the scheduling gap. For example, in some aspects, the UE 120 may determine that the signal that starts earlier in time has the higher priority, or the UE 120 may determine that the signal that ends later in time has the higher priority. Additionally, or alternatively, among two downlink signals (e.g., two SPS occasions), the signal with a lowest configuration identifier or HARQ identifier may have the higher priority, or the signal with the highest configuration identifier or HARQ identifier may have the higher priority. Additionally, or alternatively, among two uplink signals (e.g., two uplink configured grant occasions), the signal with a higher physical layer (PHY) priority may have the higher priority. In any case, if the lower priority signal spans one symbol, the UE 120 may drop the lower priority signal such that the beam switching gap includes the entire symbol. Alternatively, if the lower priority signal spans more than one symbol, the UE 120 may drop all symbols of the lower priority signal, or the UE 120 may drop only the one symbol that is adjacent to the beam switch. As shown by reference number 830, the UE 120 may then perform the beam switch in the time period with the duration that is sufficient to satisfy the relevant minimum switching time, which may include any time that is allocated in the beam switch command plus the one or more symbols that are dropped for the lower priority signal.

As indicated above, FIG. 8 is provided as an example. Other examples may differ from what is described with respect to FIG. 8.

FIG. 9 is a diagram illustrating an example process 900 performed, for example, by a mobile station, in accordance with the present disclosure. Example process 900 is an example where the mobile station (e.g., UE 120) performs operations associated with beam switch capability indication and gap time management for higher frequency bands.

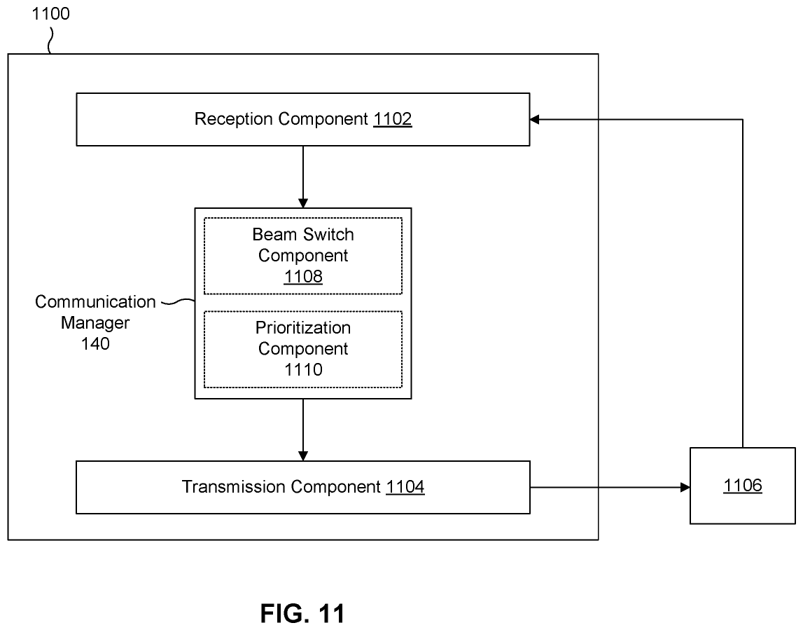

As shown in FIG. 9, in some aspects, process 900 may include transmitting beam switch capability information that indicates a minimum beam switch time for one or more beam switch types (block 910). For example, the mobile station (e.g., using communication manager 140 and/or transmission component 1104, depicted in FIG. 11) may transmit beam switch capability information that indicates a minimum beam switch time for one or more beam switch types, as described above.

As further shown in FIG. 9, in some aspects, process 900 may include receiving a command to perform a beam switch associated with a beam switch type (block 920). For example, the mobile station (e.g., using communication manager 140 and/or reception component 1102, depicted in FIG. 11) may receive a command to perform a beam switch associated with a beam switch type, as described above.

As further shown in FIG. 9, in some aspects, process 900 may include performing the beam switch in a time period between a first signal and a second signal, wherein the time period has a duration that satisfies the minimum beam switch time for the beam switch type associated with the beam switch (block 930). For example, the mobile station (e.g., using communication manager 140 and/or beam switch component 1108, depicted in FIG. 11) may perform the beam switch in a time period between a first signal and a second signal, wherein the time period has a duration that satisfies the minimum beam switch time for the beam switch type associated with the beam switch, as described above.

Process 900 may include additional aspects, such as any single aspect or any combination of aspects described below and/or in connection with one or more other processes described elsewhere herein.

In a first aspect, the one or more beam switch types are associated with a beam switch that is performed between a first downlink signal that has a first QCL assumptions for a spatial Rx parameter and a second downlink signal that has a second QCL assumptions for the spatial Rx parameter.

In a second aspect, alone or in combination with the first aspect, the one or more beam switch types are associated with a beam switch that is performed between a first downlink signal that has a QCL assumption for a spatial Rx parameter and a second downlink signal without a QCL assumption for the spatial Rx parameter.

In a third aspect, alone or in combination with one or more of the first and second aspects, the one or more beam switch types are associated with a beam switch that is performed between two downlink reference signals without QCL assumptions for a spatial Rx parameter.

In a fourth aspect, alone or in combination with one or more of the first through third aspects, the one or more beam switch types are associated with a beam switch that is performed between two downlink reference signals that share a QCL assumption for a spatial Rx parameter in a resource set with repetitions configured.

In a fifth aspect, alone or in combination with one or more of the first through fourth aspects, the one or more beam switch types are associated with a beam switch that is performed between a first uplink signal with a first spatial relation and a second uplink signal with a second spatial relation.

In a sixth aspect, alone or in combination with one or more of the first through fifth aspects, the one or more beam switch types are associated with a beam switch that is performed between a first uplink signal with a spatial relation and a second uplink signal without a spatial relation.

In a seventh aspect, alone or in combination with one or more of the first through sixth aspects, the one or more beam switch types are associated with a beam switch that is performed between two uplink reference signals without spatial relations.

In an eighth aspect, alone or in combination with one or more of the first through seventh aspects, the minimum beam switch time comprises separate values that apply to each of the one or more beam switch types.

In a ninth aspect, alone or in combination with one or more of the first through eighth aspects, the minimum beam switch time comprises a single value that applies to each of the one or more beam switch types.

In a tenth aspect, alone or in combination with one or more of the first through ninth aspects, the minimum beam switch time comprises a first value that applies to each of the one or more beam switch types that are associated with switching a downlink receive beam, and a second value that applies to each of the one or more beam switch types that are associated with switching an uplink transmit beam.

In an eleventh aspect, alone or in combination with one or more of the first through tenth aspects, the duration of the time period in which the beam switch is performed has a value that equals or exceeds a largest candidate value for the minimum beam switch time based at least in part on the beam switch being performed between adjacent SSBs.

In a twelfth aspect, alone or in combination with one or more of the first through eleventh aspects, the command configures the time period to include one or more of a cyclic prefix within a symbol or a scheduling gap based at least in part on the beam switch capability information.

In a thirteenth aspect, alone or in combination with one or more of the first through twelfth aspects, process 900 includes determining that the command configures the time period to include one or more of a cyclic prefix within a symbol or a scheduling gap that fails to satisfy the minimum beam switch time for the beam switch type associated with the beam switch, determining, among the first signal and the second signal, a signal that has a lower priority based at least in part on one or more priority rules, and dropping one or more symbols of the signal that has the lower priority such that the duration of the time period satisfies the minimum beam switch time for the beam switch type associated with the beam switch.

In a fourteenth aspect, alone or in combination with one or more of the first through thirteenth aspects, the signal that has the lower priority is one of the first signal or the second signal that starts earlier in time or ends later in time.

In a fifteenth aspect, alone or in combination with one or more of the first through fourteenth aspects, the signal that has the lower priority is one of the first signal or the second signal with a lowest identifier or a highest identifier based at least in part on the first signal and the second signal corresponding to SPS occasions.

In a sixteenth aspect, alone or in combination with one or more of the first through fifteenth aspects, the signal that has the lower priority is one of the first signal or the second signal with a lowest physical layer priority based at least in part on the first signal and the second signal corresponding to uplink signals.

In a seventeenth aspect, alone or in combination with one or more of the first through sixteenth aspects, the one or more symbols of the signal that are dropped include all symbols of the signal.

In an eighteenth aspect, alone or in combination with one or more of the first through seventeenth aspects, the one or more symbols of the signal that are dropped include only a single symbol of the signal that is adjacent to the time period in which the beam switch is performed.

In a nineteenth aspect, alone or in combination with one or more of the first through eighteenth aspects, the beam switch capability information indicates a minimum interval between consecutive beam switches.

In a twentieth aspect, alone or in combination with one or more of the first through nineteenth aspects, the beam switch capability information indicates a maximum number of SRS ports per SRS resource set.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with beam switch capability indication and gap time management for higher frequency bands.

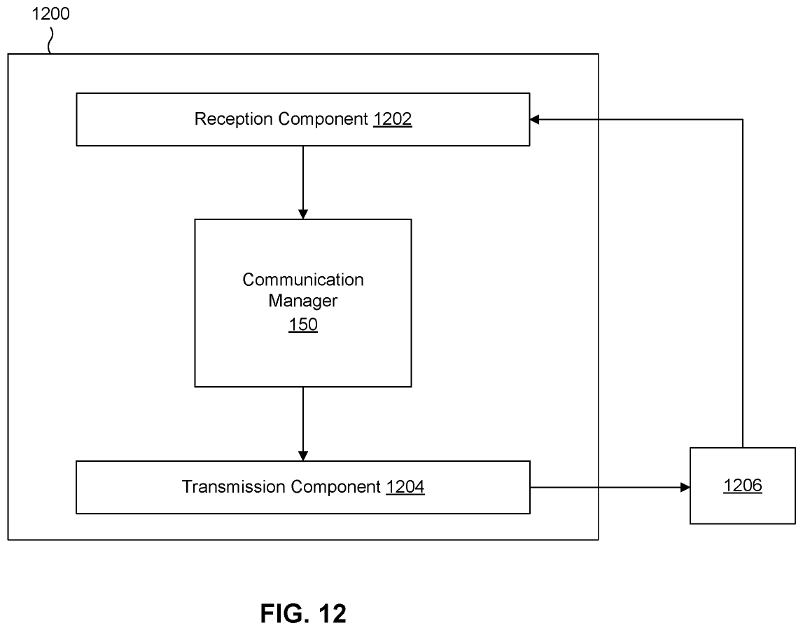

As shown in FIG. 10, in some aspects, process 1000 may include receiving beam switch capability information that indicates a minimum beam switch time for one or more beam switch types (block 1010). For example, the network node (e.g., using communication manager 150 and/or reception component 1202, depicted in FIG. 12) may receive beam switch capability information that indicates a minimum beam switch time for one or more beam switch types, as described above.

As further shown in FIG. 10, in some aspects, process 1000 may include transmitting a command to perform a beam switch associated with a beam switch type in a time period between a first signal and a second signal, wherein the time period has a duration that is based at least in part on the minimum beam switch time for the beam switch type associated with the beam switch (block 1020). For example, the network node (e.g., using communication manager 150 and/or transmission component 1204, depicted in FIG. 12) may transmit a command to perform a beam switch associated with a beam switch type in a time period between a first signal and a second signal, wherein the time period has a duration that is based at least in part on the minimum beam switch time for the beam switch type associated with the beam switch, as described above.

Process 1000 may include additional aspects, such as any single aspect or any combination of aspects described below and/or in connection with one or more other processes described elsewhere herein.

In a first aspect, the one or more beam switch types are associated with a beam switch that is performed between a first downlink signal that has a first QCL assumption for a spatial Rx parameter and a second downlink signal that has a second QCL assumption for the spatial Rx parameter.

In a second aspect, alone or in combination with the first aspect, the one or more beam switch types are associated with a beam switch that is performed between a first downlink signal that has a QCL assumption for a spatial Rx parameter and a second downlink signal without a QCL assumption for the spatial Rx parameter.

In a third aspect, alone or in combination with one or more of the first and second aspects, the one or more beam switch types are associated with a beam switch that is performed between two downlink reference signals without QCL assumptions for a spatial Rx parameter.

In a fourth aspect, alone or in combination with one or more of the first through third aspects, the one or more beam switch types are associated with a beam switch that is performed between two downlink reference signals that share a QCL assumption for a spatial Rx parameter in a resource set with repetitions configured.

In a fifth aspect, alone or in combination with one or more of the first through fourth aspects, the one or more beam switch types are associated with a beam switch that is performed between a first uplink signal with a first spatial relation and a second uplink signal with a second spatial relation.

In a sixth aspect, alone or in combination with one or more of the first through fifth aspects, the one or more beam switch types are associated with a beam switch that is performed between a first uplink signal with a spatial relation and a second uplink signal without a spatial relation.

In a seventh aspect, alone or in combination with one or more of the first through sixth aspects, the one or more beam switch types are associated with a beam switch that is performed between two uplink reference signals without spatial relations.

In an eighth aspect, alone or in combination with one or more of the first through seventh aspects, the minimum beam switch time comprises separate values that apply to each of the one or more beam switch types.

In a ninth aspect, alone or in combination with one or more of the first through eighth aspects, the minimum beam switch time comprises a single value that applies to each of the one or more beam switch types.

In a tenth aspect, alone or in combination with one or more of the first through ninth aspects, the minimum beam switch time comprises a first value that applies to each of the one or more beam switch types that are associated with switching a downlink receive beam, and a second value that applies to each of the one or more beam switch types that are associated with switching an uplink transmit beam.

In an eleventh aspect, alone or in combination with one or more of the first through tenth aspects, the duration of the time period in which the beam switch is performed has a value that equals or exceeds a largest candidate value for the minimum beam switch time based at least in part on the beam switch being performed between adjacent SSBs.

In a twelfth aspect, alone or in combination with one or more of the first through eleventh aspects, the command configures the time period to include one or more of a cyclic prefix within a symbol or a scheduling gap based at least in part on the beam switch capability information.

In a thirteenth aspect, alone or in combination with one or more of the first through twelfth aspects, the beam switch capability information indicates a minimum interval between consecutive beam switches.

In a fourteenth aspect, alone or in combination with one or more of the first through thirteenth aspects, the beam switch capability information indicates a maximum number of SRS ports per SRS resource set.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a mobile station, or a mobile station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a network node, or another wireless communication device) using the reception component 1102 and the transmission component 1104. As further shown, the apparatus 1100 may include the communication manager 140. The communication manager 140 may include one or more of a beam switch component 1108 or a prioritization component 1110, among other examples.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the mobile station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the mobile station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the mobile station described in connection with FIG. 2. In some aspects, the transmission component 1104 may be co-located with the reception component 1102 in a transceiver.

The transmission component 1104 may transmit beam switch capability information that indicates a minimum beam switch time for one or more beam switch types. The reception component 1102 may receive a command to perform a beam switch associated with a beam switch type. The beam switch component 1108 may perform the beam switch in a time period between a first signal and a second signal, wherein the time period has a duration that satisfies the minimum beam switch time for the beam switch type associated with the beam switch.

The beam switch component 1108 may determine that the command configures the time period to include one or more of a cyclic prefix within a symbol or a scheduling gap that fails to satisfy the minimum beam switch time for the beam switch type associated with the beam switch. The prioritization component 1110 may determine, among the first signal and the second signal, a signal that has a lower priority based at least in part on one or more priority rules. The beam switch component 1108 may drop one or more symbols of the signal that has the lower priority such that the duration of the time period satisfies the minimum beam switch time for the beam switch type associated with the beam switch.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include the communication manager 150.

In some aspects, the apparatus 1200 may be configured to perform one or more operations described herein in connection with FIGS. 3-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The reception component 1202 may receive beam switch capability information that indicates a minimum beam switch time for one or more beam switch types. The transmission component 1204 may transmit a command to perform a beam switch associated with a beam switch type in a time period between a first signal and a second signal, wherein the time period has a duration that is based at least in part on the minimum beam switch time for the beam switch type associated with the beam switch.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a mobile station, comprising: transmitting, by the mobile station to a network node, beam switch capability information that indicates a minimum beam switch time for one or more beam switch types; receiving, by the mobile station from the network node, a command to perform a beam switch associated with a beam switch type; and performing, by the mobile station, the beam switch in a time period between a first signal and a second signal, wherein the time period has a duration that satisfies the minimum beam switch time for the beam switch type associated with the beam switch.

Aspect 2: The method of Aspect 1, wherein the one or more beam switch types are associated with a beam switch that is performed between a first downlink signal that has a first QCL assumptions for a spatial Rx parameter and a second downlink signal that has a second QCL assumptions for the spatial Rx parameter.

Aspect 3: The method of any of Aspects 1-2, wherein the one or more beam switch types are associated with a beam switch that is performed between a first downlink signal that has a QCL assumption for a spatial Rx parameter and a second downlink signal without a QCL assumption for the spatial Rx parameter.

Aspect 4: The method of any of Aspects 1-3, wherein the one or more beam switch types are associated with a beam switch that is performed between two downlink reference signals without QCL assumptions for a spatial Rx parameter.

Aspect 5: The method of any of Aspects 1-4, wherein the one or more beam switch types are associated with a beam switch that is performed between two downlink reference signals that share a QCL assumption for a spatial Rx parameter in a resource set with repetitions configured.

Aspect 6: The method of any of Aspects 1-5, wherein the one or more beam switch types are associated with a beam switch that is performed between a first uplink signal with a first spatial relation and a second uplink signal with a second spatial relation.

Aspect 7: The method of any of Aspects 1-6, wherein the one or more beam switch types are associated with a beam switch that is performed between a first uplink signal with a spatial relation and a second uplink signal without a spatial relation.

Aspect 8: The method of any of Aspects 1-7, wherein the one or more beam switch types are associated with a beam switch that is performed between two uplink reference signals without spatial relations.

Aspect 9: The method of any of Aspects 1-8, wherein the minimum beam switch time comprises separate values that apply to each of the one or more beam switch types.

Aspect 10: The method of any of Aspects 1-8, wherein the minimum beam switch time comprises a single value that applies to each of the one or more beam switch types.

Aspect 11: The method of any of Aspects 1-8, wherein the minimum beam switch time comprises a first value that applies to each of the one or more beam switch types that are associated with switching a downlink receive beam, and a second value that applies to each of the one or more beam switch types that are associated with switching an uplink transmit beam.

Aspect 12: The method of any of Aspects 1-11, wherein the duration of the time period in which the beam switch is performed has a value that equals or exceeds a largest candidate value for the minimum beam switch time based at least in part on the beam switch being performed between adjacent SSBs.

Aspect 13: The method of any of Aspects 1-12, wherein the command configures the time period to include one or more of a cyclic prefix within a symbol or a scheduling gap based at least in part on the beam switch capability information.

Aspect 14: The method of any of Aspects 1-12, further comprising: determining that the command configures the time period to include one or more of a cyclic prefix within a symbol or a scheduling gap that fails to satisfy the minimum beam switch time for the beam switch type associated with the beam switch; determining, among the first signal and the second signal, a signal that has a lower priority based at least in part on one or more priority rules; and dropping one or more symbols of the signal that has the lower priority such that the duration of the time period satisfies the minimum beam switch time for the beam switch type associated with the beam switch.

Aspect 15: The method of Aspect 14, wherein the signal that has the lower priority is one of the first signal or the second signal that starts earlier in time or ends later in time.

Aspect 16: The method of any of Aspects 14-15, wherein the signal that has the lower priority is one of the first signal or the second signal with a lowest identifier or a highest identifier based at least in part on the first signal and the second signal corresponding to semi-persistent scheduling occasions.

Aspect 17: The method of any of Aspects 14-16, wherein the signal that has the lower priority is one of the first signal or the second signal with a lowest physical layer priority based at least in part on the first signal and the second signal corresponding to uplink signals.

Aspect 18: The method of any of Aspects 14-17, wherein the one or more symbols of the signal that are dropped include all symbols of the signal.

Aspect 19: The method of any of Aspects 14-17, wherein the one or more symbols of the signal that are dropped include only a single symbol of the signal that is adjacent to the time period in which the beam switch is performed.

Aspect 20: The method of any of Aspects 1-19, wherein the beam switch capability information indicates a minimum interval between consecutive beam switches.

Aspect 21: The method of any of Aspects 1-20, wherein the beam switch capability information indicates a maximum number of SRS ports per SRS resource set.

Aspect 22: A method of wireless communication performed by a network node, comprising: receiving, by the network node from a mobile station, beam switch capability information that indicates a minimum beam switch time for one or more beam switch types; and transmitting, by the network node to the mobile station, a command to perform a beam switch associated with a beam switch type in a time period between a first signal and a second signal, wherein the time period has a duration that is based at least in part on the minimum beam switch time for the beam switch type associated with the beam switch.

Aspect 23: The method of Aspect 22, wherein the one or more beam switch types are associated with a beam switch that is performed between a first downlink signal that has a first QCL assumption for a spatial Rx parameter and a second downlink signal that has a second QCL assumption for the spatial Rx parameter.

Aspect 24: The method of any of Aspects 22-23, wherein the one or more beam switch types are associated with a beam switch that is performed between a first downlink signal that has a QCL assumption for a spatial Rx parameter and a second downlink signal without a QCL assumption for the spatial Rx parameter.

Aspect 25: The method of any of Aspects 22-24, wherein the one or more beam switch types are associated with a beam switch that is performed between two downlink reference signals without QCL assumptions for a spatial Rx parameter.

Aspect 26: The method of any of Aspects 22-25, wherein the one or more beam switch types are associated with a beam switch that is performed between two downlink reference signals that share a QCL assumption for a spatial Rx parameter in a resource set with repetitions configured.

Aspect 27: The method of any of Aspects 22-26, wherein the one or more beam switch types are associated with a beam switch that is performed between a first uplink signal with a first spatial relation and a second uplink signal with a second spatial relation.

Aspect 28: The method of any of Aspects 22-27, wherein the one or more beam switch types are associated with a beam switch that is performed between a first uplink signal with a spatial relation and a second uplink signal without a spatial relation.

Aspect 29: The method of any of Aspects 22-28, wherein the one or more beam switch types are associated with a beam switch that is performed between two uplink reference signals without spatial relations.

Aspect 30: The method of any of Aspects 22-29, wherein the minimum beam switch time comprises separate values that apply to each of the one or more beam switch types.

Aspect 31: The method of any of Aspects 22-29, wherein the minimum beam switch time comprises a single value that applies to each of the one or more beam switch types.

Aspect 32: The method of any of Aspects 22-29, wherein the minimum beam switch time comprises a first value that applies to each of the one or more beam switch types that are associated with switching a downlink receive beam, and a second value that applies to each of the one or more beam switch types that are associated with switching an uplink transmit beam.

Aspect 33: The method of any of Aspects 22-32, wherein the duration of the time period in which the beam switch is performed has a value that equals or exceeds a largest candidate value for the minimum beam switch time based at least in part on the beam switch being performed between adjacent SSBs.

Aspect 34: The method of any of Aspects 22-33, wherein the command configures the time period to include one or more of a cyclic prefix within a symbol or a scheduling gap based at least in part on the beam switch capability information.

Aspect 35: The method of any of Aspects 22-34, wherein the beam switch capability information indicates a minimum interval between consecutive beam switches.

Aspect 36: The method of any of Aspects 22-35, wherein the beam switch capability information indicates a maximum number of SRS ports per SRS resource set.

Aspect 37: An apparatus for wireless communication at a device, comprising a processor; memory coupled with the processor; and instructions stored in the memory and executable by the processor to cause the apparatus to perform the method of one or more of Aspects 1-21.

Aspect 38: A device for wireless communication, comprising a memory and one or more processors coupled to the memory, the one or more processors configured to perform the method of one or more of Aspects 1-21.

Aspect 39: An apparatus for wireless communication, comprising at least one means for performing the method of one or more of Aspects 1-21.

Aspect 40: A non-transitory computer-readable medium storing code for wireless communication, the code comprising instructions executable by a processor to perform the method of one or more of Aspects 1-21.

Aspect 41: A non-transitory computer-readable medium storing a set of instructions for wireless communication, the set of instructions comprising one or more instructions that, when executed by one or more processors of a device, cause the device to perform the method of one or more of Aspects 1-21.

Aspect 42: An apparatus for wireless communication at a device, comprising a processor; memory coupled with the processor; and instructions stored in the memory and executable by the processor to cause the apparatus to perform the method of one or more of Aspects 22-36.

Aspect 43: A device for wireless communication, comprising a memory and one or more processors coupled to the memory, the one or more processors configured to perform the method of one or more of Aspects 22-36.

Aspect 44: An apparatus for wireless communication, comprising at least one means for performing the method of one or more of Aspects 22-36.

Aspect 45: A non-transitory computer-readable medium storing code for wireless communication, the code comprising instructions executable by a processor to perform the method of one or more of Aspects 22-36.

Aspect 46: A non-transitory computer-readable medium storing a set of instructions for wireless communication, the set of instructions comprising one or more instructions that, when executed by one or more processors of a device, cause the device to perform the method of one or more of Aspects 22-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A mobile station, comprising:
a memory; and
one or more processors configured to, based at least in part on information stored in the memory:
transmit, to a network node, beam switch capability information that indicates a minimum beam switch time for one or more beam switch types;
receive, from the network node, a command to perform a beam switch associated with a beam switch type; and
perform the beam switch in a time period between a first signal and a second signal, wherein the time period has a duration that satisfies the minimum beam switch time for the beam switch type associated with the beam switch.

2. The mobile station of claim 1, wherein the one or more beam switch types are associated with a beam switch that is performed between a first downlink signal that has a first quasi co-location (QCL) assumptions for a spatial receive (Rx) parameter and a second downlink signal that has a second QCL assumptions for the spatial Rx parameter.

3. The mobile station of claim 1, wherein the one or more beam switch types are associated with a beam switch that is performed between a first downlink signal that has a quasi co-location (QCL) assumption for a spatial receive (Rx) parameter and a second downlink signal without a QCL assumption for the spatial Rx parameter.

4. The mobile station of claim 1, wherein the one or more beam switch types are associated with a beam switch that is performed between two downlink reference signals without quasi co-location assumptions for a spatial receive parameter.

5. The mobile station of claim 1, wherein the one or more beam switch types are associated with a beam switch that is performed between two downlink reference signals that share a quasi co-location assumption for a spatial receive parameter in a resource set with repetitions configured.

6. The mobile station of claim 1, wherein the one or more beam switch types are associated with a beam switch that is performed between a first uplink signal with a first spatial relation and a second uplink signal with a second spatial relation.

7. The mobile station of claim 1, wherein the one or more beam switch types are associated with a beam switch that is performed between a first uplink signal with a spatial relation and a second uplink signal without a spatial relation.

8. The mobile station of claim 1, wherein the one or more beam switch types are associated with a beam switch that is performed between two uplink reference signals without spatial relations.

9. The mobile station of claim 1, wherein the minimum beam switch time comprises separate values that apply to each of the one or more beam switch types.

10. The mobile station of claim 1, wherein the minimum beam switch time comprises a single value that applies to each of the one or more beam switch types.

11. The mobile station of claim 1, wherein the minimum beam switch time comprises a first value that applies to each of the one or more beam switch types that are associated with switching a downlink receive beam, and a second value that applies to each of the one or more beam switch types that are associated with switching an uplink transmit beam.

12. The mobile station of claim 1, wherein the duration of the time period in which the beam switch is performed has a value that equals or exceeds a largest candidate value for the minimum beam switch time based at least in part on the beam switch being performed between adjacent synchronization signal blocks.

13. The mobile station of claim 1, wherein the command configures the time period to include one or more of a cyclic prefix within a symbol or a scheduling gap based at least in part on the beam switch capability information.

14. The mobile station of claim 1, wherein the one or more processors are further configured to:
determine that the command configures the time period to include one or more of a cyclic prefix within a symbol or a scheduling gap that fails to satisfy the minimum beam switch time for the beam switch type associated with the beam switch;
determine, among the first signal and the second signal, a signal that has a lower priority based at least in part on one or more priority rules; and
drop one or more symbols of the signal that has the lower priority such that the duration of the time period satisfies the minimum beam switch time for the beam switch type associated with the beam switch.

15. The mobile station of claim 14, wherein the signal that has the lower priority is one of the first signal or the second signal that starts earlier in time or ends later in time.

16. The mobile station of claim 14, wherein the signal that has the lower priority is one of the first signal or the second signal with a lowest identifier or a highest identifier based at least in part on the first signal and the second signal corresponding to semi-persistent scheduling occasions.

17. The mobile station of claim 14, wherein the signal that has the lower priority is one of the first signal or the second signal with a lowest physical layer priority based at least in part on the first signal and the second signal corresponding to uplink signals.

18. The mobile station of claim 14, wherein the one or more symbols of the signal that are dropped include all symbols of the signal.

19. The mobile station of claim 14, wherein the one or more symbols of the signal that are dropped include only a single symbol of the signal that is adjacent to the time period in which the beam switch is performed.

20. The mobile station of claim 1, wherein the beam switch capability information indicates a minimum interval between consecutive beam switches.

21. The mobile station of claim 1, wherein the beam switch capability information indicates a maximum number of sounding reference signal (SRS) ports per SRS resource set.

22. A method of wireless communication performed by a mobile station, comprising:
transmitting, by the mobile station to a network node, beam switch capability information that indicates a minimum beam switch time for one or more beam switch types;
receiving, by the mobile station from the network node, a command to perform a beam switch associated with a beam switch type; and
performing, by the mobile station, the beam switch in a time period between a first signal and a second signal, wherein the time period has a duration that satisfies the minimum beam switch time for the beam switch type associated with the beam switch.

23. The method of claim 22, wherein the beam switch capability information indicates a maximum number of sounding reference signal (SRS) ports per SRS resource set.

24. A non-transitory computer-readable medium storing a set of instructions for wireless communication, the set of instructions comprising:
one or more instructions that, when executed by one or more processors of a mobile station, cause the mobile station to:
transmit, to a network node, beam switch capability information that indicates a minimum beam switch time for one or more beam switch types;
receive, from the network node, a command to perform a beam switch associated with a beam switch type; and
perform the beam switch in a time period between a first signal and a second signal, wherein the time period has a duration that satisfies the minimum beam switch time for the beam switch type associated with the beam switch.

25. The non-transitory computer-readable medium of claim 24, wherein the beam switch capability information indicates a maximum number of sounding reference signal (SRS) ports per SRS resource set.

26. An apparatus for wireless communication, comprising:
means for transmitting, to a network node, beam switch capability information that indicates a minimum beam switch time for one or more beam switch types;
means for receiving, from the network node, a command to perform a beam switch associated with a beam switch type; and
means for performing the beam switch in a time period between a first signal and a second signal, wherein the time period has a duration that satisfies the minimum beam switch time for the beam switch type associated with the beam switch.

27. The apparatus of claim 26, wherein the beam switch capability information indicates a maximum number of sounding reference signal (SRS) ports per SRS resource set.
